(19) United States
(12) Patent Application Publication
(10) Pub. No.: US 2013/0280526 A1
(43) Pub. Date: Oct. 24, 2013

(54) HEAT-CURING SEALING COMPOUND COMPOSITIONS HAVING FAST SKIN FORMATION AND GOOD STORAGE STABILITY

(71) Applicants: Antonio Voci, Zurich (CH); Andreas Kramer, Zurich (CH); Jan Olaf Schulenburg, Uster (CH); Michael Gutgsell, Uster (CH); Urs Burckhardt, Zurich (CH)

(72) Inventors: Antonio Voci, Zurich (CH); Andreas Kramer, Zurich (CH); Jan Olaf Schulenburg, Uster (CH); Michael Gutgsell, Uster (CH); Urs Burckhardt, Zurich (CH)

(73) Assignee: SIKA TECHNOLOGY AG, Baar (CH)

(21) Appl. No.: 13/997,435

(22) PCT Filed: Dec. 19, 2011
(86) PCT No.: PCT/EP2011/073219

§ 371 Date: Jul. 10, 2013

(30) Foreign Application Priority Data
Dec. 23, 2010 (EP) 10196684.4

(51) Int. Cl. C09J 163/00; C09J 5/06; C09J 175/04; C09J 7/02

(52) U.S. Cl. CPC C09J 163/00; C09J 7/0203; C09J 5/06; C09J 175/04
USPC 428/349; 428/414; 427/386; 156/305; 523/400; 252/511; 252/500; 252/512

(57) ABSTRACT

The invention relates to heat-curing sealing compound compositions comprising at least epoxy resin, a heat-activatable hardening agent or accelerators (B) for epoxy resins, isocyanate group-containing polyurethane polymer (PUP) and a special polyaldimine. Said single-component sealing compound compositions are characterized by a good skin formation time and extraordinarily good storage stability and low blistering. Due to these properties, said sealing compound compositions are optimally suitable for use as sealants in autobody work because they can be excellently coated with a KTL paint.

### TECHNICAL FIELD

The invention relates to the field of sealing compounds for automotive body work in particular.

### PRIOR ART

In automotive body work, individual metal plates are joined together. The metal plates that are used are oiled to reduce corrosion as much as possible. The metal plates required for this are cut to the proper shape by punching in particular and then are shaped. The cut surfaces have little or no oil coating due to the cutting.

Typically the vehicle body will be passed through a CDC bath (CDC=cathodic dip coating) at the end of assembly of the body, so that the body is coated with a so-called CDC paint, which is then baked in a CDC oven. Good CDC coating over the full surface area forms the basis for long-term use of a vehicle because it makes a significant contribution toward corrosion resistance. However, it has been found that the CDC coating is not deposited at all or is deposited only in a very small thickness on the cut surfaces of the sheet metal plates in particular, which is why these locations are especially critical. Therefore, there have been previous attempts to apply sealing compounds to these cut surfaces and/or cut edges. However, problems have often occurred here in use of such a sealing compound. In some cases, the sealing compound does not adhere to the oil-coated areas near the cut surface. If the oil is removed in these areas before applying the sealing compound, then the problem is merely shifted from the cut surface to the edge of the sealing compound, so this is not actually a feasible approach to solving the problem. In other cases, the sealing compound is not yet cured when it passes through cleaning and the CDC bath, so it dissolves during the cleaning or in the CDC bath, which on the one hand leads to unwanted contamination of the CDC bath while on the other hand causing a weakening of the sealing compound. To solve this problem, WO 2008/077918 A1 has already proposed that a UV crosslinking or heat crosslinking sealing compound or a two-component sealing compound should be used in the form of an epoxy resin sealing compound or a polyurethane sealing compound or a (meth)acrylate sealing compound. However, this has the major disadvantage that either additional equipment must be brought to the production line for the heat crosslinking or UV crosslinking and/or problems may occur with the pot life and/or with the precise dosing of the two-component sealing compound. Furthermore, application installations for two-component sealing compounds are considerably more expensive to acquire and maintain than those for single-component sealing compounds.

### SUMMARY OF THE INVENTION

The object of the present invention is therefore to make available a single-component sealing composition which adheres well to oil-coated sheet metal, need not be cured with heat or UV radiation before being immersed in a paint bath and nevertheless rapidly builds up strength.

It has surprisingly been found that heat curing sealing compound compositions according to claim 1 achieve this object.

The heat-curing sealing compound compositions have a dual curing mechanism. On the one hand, there is rapid formation of a skin due to the reaction of polyisocyanates with polyaldimines in contact with air and/or atmospheric humidity; this ensures that the sealing compound can pass through the CDC bath undamaged. The paint may be deposited on the sealing compound in a high-quality application. In another step, the sealing compound cures due to heat such as that prevailing in the CDC oven, forming a fully cured sealing compound which has an advantageous blister pattern. Furthermore, the heat-curing sealing compound compositions have excellent storage stability.

The heat-curing sealing compound composition is therefore suitable for use as a sealing compound in automotive bodies in particular.

Additional aspects of the invention are the subject matter of further independent claims. Especially preferred embodiments of the invention are the subject matter of the dependent claims.

### Methods of Implementing the Invention

The present invention relates to heat curing sealing compound compositions, which comprise:
at least one epoxy resin (A) having more than one epoxy group per molecule on the average;
at least one heat-activatable curing agent or accelerator (B) for epoxy resins;
at least one polyurethane polymer (PUP) having isocyanate groups as well as
at least one polyaldimine (PA) of formula (I)

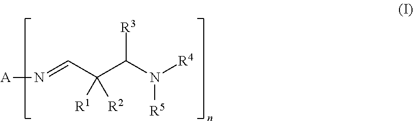

wherein
A stands for the radical of an amine after removal of n primary aliphatic amino groups and does not contain any active hydrogen atoms, n stands for 2 or 3 or 4 or 5 preferably 2 or 3, and
R¹ and R² either
   independently of one another each stand for a monovalent hydrocarbon radical having 1 to 12 carbon atoms
or
   together they stand for a divalent hydrocarbon radical having 4 to 12 carbon atoms, which is part of an optionally substituted carbocyclic ring have 5 to 8, preferably 6 carbon atoms;
R³ stands for a hydrogen atom or an alkyl group or an aralkyl group or an alkoxycarbonyl group, in particular having 1 to 12 carbon atoms;
R⁴ and R⁵
   independently of one another each stand for a monovalent aliphatic, cycloaliphatic or araliphatic radical having 1 to 20 carbon atoms, optionally containing heteroatoms in the form of ether oxygen or tertiary amine nitrogen,
or
   together stand for a divalent aliphatic radical having 3 to 20 carbon atoms which is part of an optionally substituted heterocyclic ring having 5 to 8, preferably 6 ring atoms, this ring optionally containing additional heteroatoms in addition to the nitrogen atom in the form of either oxygen or tertiary amine nitrogen.

The term “polymer” in the present document refers on the one hand to a group of macromolecules that are chemically uniform but are different with respect to the degree of polymerization, the molecular weight and the chain length and are synthesized by a polyreaction (polymerization, polyaddition, polycondensation). On the other hand, this term also includes derivatives of such a group of macromolecules from polyreactions, i.e., compounds obtained by reactions, for example, addition or substitution of functional groups on predetermined molecules and which may be chemically uniform or chemically heterogeneous. This term additionally also includes so-called prepolymers, i.e., reactive oligomeric precursors whose functional groups are involved in the structure of the macromolecules.

The term “polyurethane polymer” includes all polymers synthesized by the so-called diisocyanate polyaddition process. This also includes polymers which are almost or entirely free of urethane groups. Examples of polyurethane polymers include polyether polyurethanes, polyester polyurethanes, polyether polyureas, polyureas, polyester polyureas, polyisocyanurates and polycarbodiimides (Houben Weyl “Methoden der organischen Chemie [Methods of Organic Chemistry],” Thieme Verlag, Stuttgart 1987, Vol. E20, page 1561).

Substance names that begin with “poly-” such as polyisocyanate, polyaldimine, polyamine, polyol, polymercaptans or polyglycidyl ethers in the present document refer to substances formally containing two or more functional groups, which also appear in their name, per molecule.

The term “molecular weight” in the present document refers to the average molecular weight Mₙ.

Room temperature of the present documents is understood to be a temperature of 25° C.

Designations marked in bold such as A, PI, PA, A, B, B′, PUP, PAM, ALD, C, Y1, Y2, F, G, SM, KA, KN, R, S, S2 or the like in the present document are used only to facilitate an understanding in reading and identification.

The term “vehicle” in this document is understood to refer to any means of transport by water, by land and by air. Such means of transport include in particular ships, wheeled vehicles, such as automobiles, buses, cars, trucks and rail vehicles such as streetcars and railway vehicles.

The term “primary amino group” in the present document refers to an amino group in the form of an NH₂ group bound to an organic radical. Consequently, a “primary amine” is a molecule having a primary amino group.

The term “secondary amino group” denotes an amino group in which the nitrogen atom is bound to two organic radicals which together may also be part of a ring. Consequently, a “secondary amine” is a molecule which has a secondary amino group.

The term “tertiary amino group” denotes an amino group in which the nitrogen atom is bound to three organic radicals, such that two of these radicals together may also be part of a ring (=tertiary amine nitrogen). Consequently, a “tertiary amine” is a molecule which has a tertiary amino group.

“Aliphatic” refers to an amine or an amino group, in which the nitrogen atom is bound exclusively to aliphatic, cycloaliphatic or araliphatic radicals. The term “epoxide group” or “epoxy group” is understood to refer to the structural element

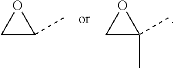

“Glycidyl ether” refers to an ether of 2,3-epoxy-1-propanol (glycidol).

The dashed lines in the formulas in this document in each case represent the bond between the respective substituent and the respective molecular radical.

The heat-curing sealing compound composition is a single-component composition.

A “single-component” composition in the present document denotes a curable composition in which all the ingredients of the composition are mixed and stored together in the same container and which are stable in storage over a lengthy period of time at room temperature, so they undergo little or no significant change in their use properties or application properties due to storage, and such a composition cures following application by the action of moisture and/or heat.

The epoxy resin (A) having an average of more than one epoxy group per molecule is preferably a liquid epoxy resin or a solid epoxy resin. The term “solid epoxy resin” is well-known to the skilled person in epoxy chemistry and is used in contrast with “liquid epoxy resins.” The glass transition temperature of solid resins is higher than room temperature, i.e., they can be pulverized into pourable bulk powders at room temperature.

Preferred solid epoxy resins have formula (X)

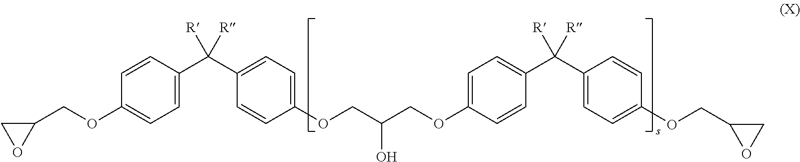

where the substituents R′ and R″, independently of one another, stand for either H or CH₃. In addition, the index s stands for a value of >1.5, in particular from 2 to 12.

Such solid epoxy resins are available commercially from Dow, Huntsman or Hexion, for example.

Compounds of formula (X) with an index s between 1 and 1.5 are known to those skilled in the art as semisolid epoxy resins. For the present invention, they are also considered to be solid resins. However, epoxy resins in the narrower sense are preferred, i.e., where the index s has a value of >1.5.

Preferred liquid epoxy resins have formula (XI)

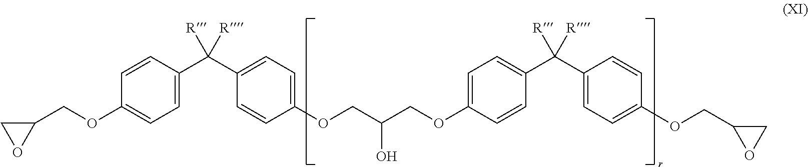

where the substituents R′″ and R″″, independently of one another, stand for either H or CH₃. In addition, the index r stands for a value from 0 to 1, but r preferably stands for a value of less than 0.2.

These are thus preferably diglycidyl ethers of bisphenol A (DGEBA), of bisphenol F and of bisphenol A/F (the designation A/F here refers to a mixture of acetone with formaldehyde, used as reactants in the synthesis thereof). Such liquid resins are obtained, for example, as Araldite® GY 250, Araldite® PY 304, Araldite® GY 282 (Huntsman) or D.E.R.™ 331 or D.E.R.™ (Dow) or Epikote 828 (Hexion).

In addition, so-called novolacs are also suitable as epoxy resin (A). These have the following formulas in particular:

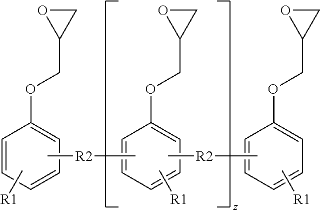

where R2=

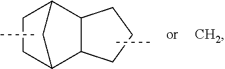

R1=H or methyl and z=0 to 7.

These are in particular phenol or cresol novolacs (R2=CH₂).

Such epoxy resins are commercially available under the brand names EPN or ECN as well as Tactix® 556 from Huntsman or as the D.E.N.™ product series from Dow Chemical.

The epoxy resin (A) is preferably a liquid epoxy resin of the formula (XI). In an even more preferred embodiment, the heat curing epoxy resin composition contains at least one liquid epoxy resin of formula (XI) as well as at least one solid epoxy resin of formula (X).

The epoxy resin (A) is typically used in an amount between 1% and 50% by weight, in particular between 3% and 30% by weight, preferably between 5% and 20% by weight, based on the weight of the heat curing sealing compound composition.

The weight ratio of epoxy resin (A) to isocyanate group-containing polyurethane polymer (PUP) is preferably between 0.1 and 0.5, in particular between 0.15 and 0.4, preferably between 0.2 and 0.3.

Furthermore, the heat curing sealing compound composition contains at least one heat-activatable curing agent or accelerator (B) for epoxy resins. In particular this is dicyanodiamide, guanamines, guanidines, aminoguanidines and derivatives thereof; substituted ureas, imidazoles and imidazole salts, imidazolines, amidoamines, iminoamines as well as amine complexes of a Lewis acid.

The substituted ureas are aromatic or nonaromatic ureas. Suitable aromatic ureas include in particular 3-(3-chloro-4-methylphenyl)-1,1-dimethyl urea (chlortolurone), p-chlorophenyl-N,N-dimethyl urea (monuron), 3-phenyl-1,1-dimethyl urea (fenuron) or 3,4-dichlorophenyl-N,N-dimethyl urea (diuron).

The heat-activatable curing agent or accelerator (B) for epoxy resins is preferably a nonaromatic urea. Such a nonaromatic urea especially preferably has formula (VIII-a) or (VIII-b)

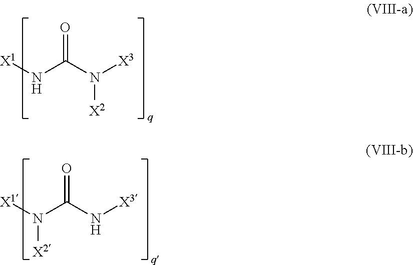

wherein X¹ stands for H or a q-valent aliphatic, cycloaliphatic or araliphatic radical;
X² and X³ either
   each stand for an alkyl group or an aralkyl group,
or
   together stand for a divalent aliphatic radical having 3 to 20 carbon atoms, which is part of an optionally substituted heterocyclic ring having 5 to 8, preferably 6 ring atoms;
X^{1′} stands for a q′-valent aliphatic, cycloaliphatic or araliphatic radical;
X^{2′} stands for an alkyl group or aralkyl group or alkylene group;
X^{3′} independently of one another stand fors H or an alkyl group or aralkyl group, and
q and q′ each stand for a value of 1 to 4, in particular 1 or 2.

Such nonaromatic ureas of formula (VIII-a) or (VIII-b) as well as their synthesis are described in detail in US 2010/0273005 A1, the total content of which is herewith included by this reference.

Suitable nonaromatic ureas include in particular N,N-dialkyl ureas, N-isobutyl-N′,N′-dimethyl urea and 1,1′-(hexane-1,6-diyl)-bis-(3,3′-dimethyl urea).

N,N′-Dialkyl ureas having C₁ to C₄ alkyl chains, in particular N,N-dimethyl urea have proven to be especially suitable.

Amine complexes of a Lewis acid are complexes which are formed between an amine and a Lewis acid. Suitable amines include in particular amines with a molecular weight of less than 130 g/mol, in particular between 40 and 110 g/mol, preferably between 40 and 90 g/mol. These are tertiary or secondary amines in particular. Suitable tertiary amines include in particular trialkylamines such as triethylamine, trimethylamine, tripropylamine, tributylamine or dimethylpropylamine. Furthermore, aromatic tertiary amines such as dimethylbenzylamine or dimethylaminopyridine as well as nitrogen aromatic amines such as pyridine are also suitable.

Secondary amines include in particular dialkylamines such as dimethylamine, diethylamine, dipropylamine or dibutylamine as well as cycloaliphatic secondary amines such as pyrrolidine, piperidine or morpholine.

The Lewis acid may be in particular boron trihalides, in particular BCl₃ or BF₃. BCl₃ is preferred.

Both the BCl₃ diethylamine complex and the BCl₃ amine complex, which can be obtained as OMICURE™ BC-120 (from Emerald Performance Materials) have proven to be especially suitable amine complexes of a Lewis acid.

The heat-activatable curing agent or accelerator (B) for epoxy resins is preferably solid at room temperature and has a melting point of more than 80° C., in particular more than 100° C.

Especially preferred heat-activatable curing agents and accelerators (B) include substituted ureas, in particular 3-(3-chloro-4-methylphenyl)-1,1-dimethyl urea (chlortoluron), p-chlorophenyl-N,N-dimethyl urea (monuron), 3-phenyl-1,1-dimethyl urea (fenuron), 3,4-dichlorophenyl-N,N-dimethyl urea (diuron), N,N-dimethyl urea, N-isobutyl-N′,N′-dimethyl urea and 1,1′-(hexane-1,6-diyl)-bis-(3,3′-dimethyl urea).

In addition, the heat-activatable curing agent or accelerator (B) is especially preferably an amidoamine having a primary amino group, in particular one such that can be obtained by the reaction of phthalic anhydride and a polyamine having primary amino groups, in particular diethylene triamine (DETA) or triethylene tetramine (TETA).

The most preferred heat-activatable curing agents or accelerators (B) are N,N-dimethyl urea and dicyanodiamide.

It is possible for the dicyanodiamide to be present in a finely divided form and to have an average particle size of <12 μm, in particular from 1 to 10 μm, preferably between 5 and 9 μm. The particle size is determined here by means of a screen.

It may also be appropriate and quite advantageous that mixtures of two or more different heat-activatable curing agents or accelerators (B) are used.

The heat-activatable curing agents or accelerators (B) are largely stable at room temperature in the presence of epoxy resins. Only at elevated temperatures do they become active and lead to the curing of the epoxy resins. The activation temperature depends on the heat-activatable curing agent or accelerator (B) used and is typically more than 120° C.

The heat-activatable hardener or accelerator (B) is typically used in an amount between 0.05% and 7% by weight, in particular between 0.1 and 5% by weight, preferably between 0.25% and 2% by weight, based on the weight of the heat-curing sealing compound composition.

The heat-curing sealing compound composition also contains at least one polyurethane polymer (PUP) which contains isocyanate groups.

A suitable polyurethane polymer (PUP) can be obtained in particular by the reaction of at least one polyol with at least one polyisocyanate. This reaction can take place by reacting the polyol and the polyisocyanate by conventional methods, for example, at temperatures of 50° C. to 100° C., optionally with the joint use of suitable catalysts, such that the polyisocyanate is dosed so that its isocyanate groups are present in a stoichiometric excess in relation to the hydroxyl groups of the polyol. The polyisocyanate is advantageously dosed so that an NCO/OH ratio of 1.3 to 5 is maintained, in particular 1.5 to 3. The term “NCO/OH ratio” is understood to refer to the ratio of the number of isocyanate groups used to the number of hydroxyl groups used. A free isocyanate group content of 0.5 to 15% by weight, especially preferably 0.5 to 5% by weight, preferably remains in the polyurethane polymer (PUP) after the reaction of all the hydroxyl groups of the polyol.

The polyurethane polymer (PUP) may optionally be synthesized with the concurrent use of plasticizers, where the plasticizers used do not contain any groups that are reactive with isocyanates.

For example, the following commercial polyols or mixtures thereof may be used as the polyols for synthesis of a polyurethane polymer (PUP):
Polyoxyalkylene polyols, also known as polyether polyols or oligo etherols which are polymerization products of ethylene oxide, 1,2-propylene oxide, 1,2- or 2,3-butylene oxide, oxetane, tetrahydrofuran or mixtures thereof, optionally polymerized with the help of an initiator molecule having two or more active hydrogen atoms such as, for example, water, ammonia or compounds having several OH or NH groups such as, for example, 1,2-ethane diol, 1,2-propane diol and 1,3-propane diol, neopentyl glycol, diethylene glycol, triethylene glycol, the isomeric dipropylene glycols and tripropylene glycols, the isomeric butane diols, pentane diols, hexane diols, heptane diols, octane diols, nonane diols, decane diols, undecane diols, 1,3- and 1,4-cyclohexane dimethanol, bisphenol A, hydrogenated bisphenol A, 1,1,1-trimethylol ethane, 1,1,1-trimethylol propane, glycerol, aniline as well as mixtures of the compounds listed above. Polyoxyalkylene polyols which have a low degree of unsaturation (measured according to ASTM D-2849-69 and given in milliequivalents of unsaturation per gram of polyol (mEq/g)), synthesized with the help of so-called double-metal cyanide complex catalysts (DMC catalysts) as well as polyoxyalkylene polyols having a higher degree of unsaturation, synthesized with the help of anionic catalysts, for example, such as NaOH, KOH, CsOH or alkali alkoxides may also be used. Polyoxyalkylene diols or polyoxyalkylene triols, in particular polyoxyethylene and polyoxypropylene diols and triols are especially suitable. Polyoxyalkylene diols and triols having a degree of unsaturation of less than 0.02 mEq/g and having a molecular weight in the range of 1000-30,000 g/mol as well as polyoxypropylene diols and triols having a molecular weight of 400-8000 g/mol are especially suitable. Also especially suitable are so-called ethylene oxide terminated (EO end-capped, ethylene oxide end-capped) polyoxypropylene polyols. The latter are special polyoxypropylene polyoxyethylene polyols which are obtained, for example, by further alkoxylation of pure polyoxypropylene polyols, in particular polyoxypropylene diols and triols, after the end of the polypropoxylation reaction with ethylene oxide and therefore containing primary hydroxyl groups.
Styrene acrylonitrile grafted or acrylonitrile methyl methacrylate grafted polyether polyols.
Polyester polyols, also known as oligoesterols, synthesized by known methods, in particular by polycondensation of hydroxycarboxylic acids or polycondensation of aliphatic and/or aromatic polycarboxylic acids with alcohols having a valence of 2 or more.

Suitable polyester polyols include in particular those synthesized from divalent to trivalent, in particular divalent alcohols such as, for example, ethylene glycol, diethylene glycol, propylene glycol, dipropylene glycol, neopentyl glycol, 1,4-butane diol, 1,5-pentane diol, 3-methyl-1,5-hexane diol, 1,6-hexane diol, 1,8-octane diol, 1,10-decane diol, 1,12-dodecane diol, 1,12-hydroxystearyl alcohol, 1,4-cyclohexane dimethanol, dimeric fatty acid diol (dimer diol), hydroxypivalic acid neopentyl glycol ester, glycerol, 1,1,1-trimethylol propane or mixtures of the alcohols mentioned above with organic di- or tricarboxylic acids, in particular dicarboxylic acids or the anhydrides or esters thereof such as, for example, succinic acid, glutaric acid, adipic acid, trimethyl adipic acid, suberic acid, azelaic acid, sebacic acid, dodecane dicarboxylic acid, maleic acid, fumaric acid, dimer fatty acid, phthalic acid, phthalic anhydride, isophthalic acid, terephthalic acid, dimethyl terephthalate, hexahydro phthalic acid, trimellitic acid and trimellitic anhydride or mixtures of the acids mentioned above as well as polyester polyols of lactones such as, for example, ε-caprolactone and initiators, such as the divalent or trivalent alcohols mentioned above.

Especially suitable polyester polyols are polyester diols.
Polycarbonate polyols such as those accessible by reacting, for example, the alcohols mentioned above (which are used for synthesis of the polyester polyols) with dialkyl carbonates, diaryl carbonates or phosgene.
Blocked copolymers which have at least two hydroxyl groups and have at least two different blocks with a polyether, a polyester and/or polycarbonate structure of the type described above, in particular polyether polyester polyols.
Polyacrylate and polymethacrylate polyols.
Polyhydroxy functional fats and oils, for example, natural fats and oils, in particular castor oil; or so-called oleochemical polyols obtained by chemical modification of natural fats and oils, for example, the epoxy polyesters and/or epoxy polyethers obtained by epoxidation of unsaturated oils and subsequent ring opening with carboxylic acids and/or alcohols, or polyols obtained by hydroformylation and hydrogenation of unsaturated oils; or polyols obtained from natural fats and oils by degradation processes such as alcoholysis or ozonolysis and subsequent chemical linkage, for example, by transesterification or dimerization of the resulting degradation products or derivatives thereof. Suitable degradation products of natural fats and oils include in particular fatty acids and fatty alcohols as well as fatty acid esters, in particular the methyl esters (FAME), which can be derivatized by hydroformylation and hydrogenation, for example, to form hydroxy fatty acid esters.
Polyhydrocarbon polyols, also known as oligohydrocarbonols, such as, for example, polyhydroxy functional polyolefins, polyisobutylenes, polyisoprenes; polyhydroxy functional ethylene propylene, ethylene butylene or ethylene propylene diene copolymers such as those produced by the company Kraton Polymers, for example; polyhydroxy functional polymers of dienes, in particular 1,3-butadiene, which may also be synthesized in particular by anionic polymerization; polyhydroxy functional copolymers of dienes such as 1,3-butadiene or diene mixtures and vinyl monomers such as styrene, acrylonitrile, vinyl chloride, vinyl acetate, vinyl alcohol, isobutylene and isoprene, for example, polyhydroxy functional acrylonitrile butadiene copolymers, such as those that can be synthesized from epoxies or amino alcohols and carboxy terminated acrylonitrile butadiene copolymers (for example, available commercially under the brand names Hypro® (previously Hycar®) CTBN and CTBNX and ETBN from Nanoresins AG, Germany and/or Emerald Performance Materials LLC; as well as hydrogenated polyhydroxy functional polymers or copolymers of dienes.

The polyols mentioned above preferably have an average molecular weight of 250-30,000 g/mol, in particular 400-20,000 g/mol, and they preferably have an average OH functionality in the range of 1.6 to 3.

Preferred polyols include polyether polyols, polyester polyols, polycarbonate polyols, polyacrylate polyols and polyhydrocarbon polyols, preferably diols and triols. Especially preferred are polyhydrocarbon polyols, in particular polyhydroxy functional polyolefins and polyhydroxy functional polymers of dienes, in particular 1,3-butadiene.

In addition to the polyols mentioned above, small amounts of low-molecular divalent or polyvalent polyols such as, for example, 1,2-ethane diol, 1,2-propane diol and 1,3-propane diol, neopentyl glycol, diethylene glycol, triethylene glycol, the isomeric dipropylene glycols and tripropylene glycols, the isomeric butane diols, pentane diols, hexane diols, heptane diols, octane diols, nonane diols, decane diols, undecane diols, 1,3- and 1,4-cyclohexane dimethanol, hydrogenated bisphenol A, dimeric fatty alcohols, 1,1,1-trimethylol ethane, 1,1,1-trimethylol propane, glycerol, pentaerythritol, sugar alcohols such as xylitol, sorbitol or mannitol, sugars such as sucrose, other higher valency alcohols, low-molecular alkoxylation products of the divalent and polyvalent alcohols mentioned above and mixtures of the alcohols mentioned above may also be used in the synthesis of the polyurethane polymer (PUP). Likewise, small amounts of polyols with an average OH functionality of more than 3 may be used, for example, sugar polyols.

Aromatic or aliphatic polyisocyanates, in particular diisocyanates, are used as the polyisocyanate for synthesis of a polyurethane polymer (PUP) that contains isocyanate groups.

Suitable aromatic polyisocyanates include in particular monomeric di- or triisocyanates such as 2,4- and 2,6-toluoylene diisocyanate and any mixtures of these isomers (TDI), 4,4′-, 2,4′- and 2,2′-diphenylmethane diisocyanate and any mixtures of these isomers (MDI), mixtures of MDI and MDI homologs (polymeric MDI or PMDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODD, dianisidine diisocyanate (DADI), 1,3,5-tris-(isocyanatomethyl)benzene, tris-(4-isocyanatophenyl)methane, tris-(4-isocyanatophenyl)thiophosphate, oligomers and polymers of the isocyanates mentioned above as well as any mixtures of the isocyanates mentioned above. MDI and TDI are preferred.

Suitable aliphatic polyisocyanates include in particular monomeric di- or triisocyanates such as 1,4-tetramethylene diisocyanate, 2-methylpentamethylene 1,5-diisocyanate, 1,6-hexamethylene diisocyanate (HDI), 2,2,4- and 2,4,4-trimethyl-1,6-hexamethylene diisocyanate (TMDI), 1,10-decamethylene diisocyanate, 1,12-dodecamethylene diisocyanate, lysine and lysine ester diisocyanate, cyclohexane 1,3- and 1,4-diisocyanate, 1-methyl-2,4- and -2,6-diisocyanatocyclohexane and any mixtures of these isomers (HTDI or H₆TDI), 1-isocyanato-3,3,5-trimethyl-5-isocyanatomethyl cyclohexane (=isophorone diisocyanate or IPDI), perhydro-2,4′- and -4,4′-diphenylmethane diisocyanate (HMDI or H₁₂MDI), 1,4-diisocyanato-2,2,6-trimethyl-cyclohexane (TMCDI), 1,3- and 1,4-bis-(isocyanatomethyl)cyclohexane, m- and p-xylylene diisocyanate (m- and p-XDI), m- and p-tetramethyl-1,3- and -1,4-xylylene diisocyanate (m- and p-TMXDI), bis-(1-isocyanato-1-methylethyl)naphthalene, dimeric and trimeric fatty acid isocyanates such as 3,6-bis-(9-isocyanatononyl)-4,5-di-(1-heptenyl)cyclohexene (dimeryl diisocyanate), α,α,α′,α′,α″,α″-hexamethyl-1,3,5-mesitylene triisocyanate, oligomers and polymers of the isocyanates mentioned above as well as any mixtures of the isocyanates mentioned above. HDI and IPDI are preferred.

Polyurethane polymers (PUP) with aromatic isocyanate aromatic groups are preferred.

The amount of isocyanate group-containing polyurethane polymers (PUP) is typically between 10% and 70% by weight, in particular between 15 and 50% by weight, preferably between 20% and 40% by weight, based on the weight of the heat-curing sealing compound composition.

The polyurethane polymer (PUP) containing isocyanate groups is especially preferably synthesized in the presence of epoxy resin (A) with an average of more than one epoxy group per molecule, in particular liquid epoxy resin of formula (XI) in a premix (VM). It is clear to those skilled in the art that a premix (VM) will also contain, in addition to the polyurethane polymer (PUP) containing isocyanate groups and the epoxy resin (A), certain amounts of reaction products of the polyurethane polymer (PUP) containing isocyanate groups and/or the polyisocyanates used to synthesize the same, with the hydroxy functional substances that occur in epoxy resin (A), in particular the compound of formula (XII).

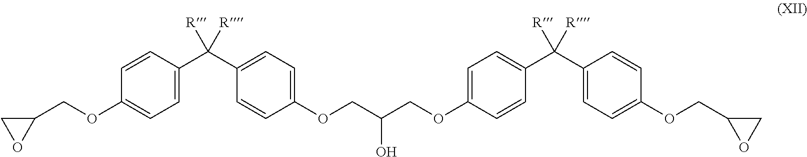

The premix (VM) thus contains both isocyanate groups and epoxy groups.

The heat-curing sealing compound composition also contains at least one polyaldimine (PA) of formula (I)

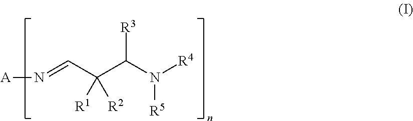

where A stands for the radical of an amine after removal of n primary aliphatic amino groups and containing no active hydrogen atoms. In addition, n stands for 2 or 3 or 4 or 5, preferably for 2 or 3. Furthermore, either R¹ and R², independently of one another, each stands for a monovalent hydrocarbon radical having 1 to 12 carbon atoms or R¹ and R² together stand for a divalent hydrocarbon radical with 4 to 12 carbon atoms, which is part of an optionally substituted carbocyclic ring having 5 to 8 carbon atoms, preferably 6 carbon atoms.

R³ stands for a hydrogen atom or an alkyl group or an aralkyl group or an alkoxy carbonyl group, in particular having 1 to 12 carbon atoms.

Either R⁴ and R⁵, independently of one another, each stands for a monovalent aliphatic, cycloaliphatic or araliphatic radical having 1 to 20 carbon atoms, optionally containing heteroatoms in the form of ether oxygen or tertiary amine oxygen, or R⁴ and R⁵ together stand for a divalent aliphatic radical having 3 to 20 carbon atoms, which is part of an optionally substituted heterocyclic ring having 5 to 8 ring atoms, preferably 6 ring atoms, where this ring also contains, in addition to the nitrogen atom, other heteroatoms in the form of ether oxygen or tertiary amine nitrogen.

Polyaldimines (PA) of formula (I) can be synthesized from polyamines (PAM) with two or more primary amino groups and aldehydes of formula (IV).

Suitable polyamines (PAM) having two or more primary amino groups that are suitable in particular include:
aliphatic, cycloaliphatic or araliphatic diamines, for example, ethylenediamine, 1,2-propanediamine, 1,3-propanediamine, 2-methyl-1,2-propanediamine, 2,2-dimethyl-1,3-propanediamine, 1,3-butanediamine, 1,4-butanediamine, 1,3-pentanediamine (DAMP), 1,5-pentanediamine, 1,5-diamino-2-methylpentane (MPMD), 1,6-hexanediamine, 2,5-dimethyl-1,6-hexanediamine, 2,2,4- and 2,4,4-trimethylhexamethylenediamine (TMD), 1,7-heptanediamine, 1,8-octanediamine, 1,9-nonanediamine, 1,10-decanediamine, 1,11-undecanediamine, 1,12-dodecanediamine, and methyl-bis-(3-aminopropyl)amine, 1,2-, 1,3- and 1,4-diaminocyclohexane, bis-(4-aminocyclohexyl)methane, bis-(4-amino-3-methyl cyclohexyl)methane, bis-(4-amino-3-ethyl cyclohexyl)methane, bis-(4-amino-3,5-dimethyl cyclohexyl)methane, bis-(4-amino-3-ethyl-5-methylcyclohexyl)methane (M-MECA), 1-amino-3-aminomethyl-3,5,5-trimethylcyclohexane (=isophorone diamine or IPDA), 2- and 4-methyl-1,3-diaminocyclohexane and mixtures thereof, 1,3- and 1,4-bis-(aminomethyl)cyclohexane, 2,5(2,6)-bis-(amino-methyl)bicyclo[2.2.1]heptane (NBDA), 3(4),8(9)-bis-(aminomethyl)-tricyclo-[5.2.1.0^{2,6}]decane, 1,4-diamino-2,2,6-trimethylcyclohexane (TMCDA), 3,9-bis-(3-aminopropyl)-2,4,8,10-tetraoxaspiro[5.5]undecane as well as 1,3- and 1,4-xylylene diamine;
aliphatic diamines containing ether groups, for example, bis-(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine and higher oligomers of these diamines, bis-(3-aminopropyl)polytetrahydrofurans and other polytetrahydrofuran diamines having molecular weights in the range of, for example, 350 to 5200 as well as polyoxyalkylene diamines. The latter are typically products of the amination of polyoxyalkylene diols and can be obtained, for example, under the name Jeffamine® (from Huntsman Chemicals), under the name polyether amine (from BASF) or under the name PC Amine® (from Nitroil). Especially suitable polyoxyalkylene diamines include Jeffamine® D-230, Jeffamine® D-400, Jeffamine® D-2000, Jeffamine® D-4000, Jeffamine® XTJ-511, Jeffamine® ED-600, Jeffamine® ED-900, Jeffamine® ED-2003, Jeffamine® XTJ-568, Jeffamine® XTJ-569, Jeffamine® XTJ-523, Jeffamine® XTJ-536, Jeffamine® XTJ-542, Jeffamine® XTJ-559, polyether amine D 230, polyether amine D 400 and polyether amine D 2000, PC Amine® DA 250, PC Amine® DA 400, PC Amine® DA 650 and PC Amine® DA 2000;
aliphatic triamines such as 4-aminomethyl-1,8-octane diamine, 1,3,5-tris(aminomethyl)benzene, 1,3,5-tris-(aminomethyl)cyclohexane:
primary polyoxyalkylene triamines, which are typically the products of the amination of polyoxyalkylene triols and can be obtained, for example, under the brand name Jeffamine® (from Huntsman Chemicals), under the name polyether amine (from BASF) or under the name PC Amine® (from Nitroil) such as for example, Jeffamine® T-403, Jeffamine® T-5000; polyether amine T 403, polyether amine T 5000; and PC Amine® TA 403, PC Amine® TA 5000.

Preferred polyamines (PAM) include polyamines selected from the group consisting of 1,6-hexamethylenediamine, MPMD, DAMP, IPDA, TMD, 1,3-xylylenediamine, 1,3-bis-(aminomethyl)cyclohexane, bis-(4-aminocyclo-hexyl)methane, bis-(4-amino-3-methyl-cyclohexyl)methane, 3(4),8(9)-bis-(aminomethyl)tricyclo-[5.2.1.0^{2,6}]decane, 1,2-, 1,3- and 1,4-diaminocyclohexane, 1,4-diamino-2,2,6-trimethylcyclohexane, 3,6-dioxaoctane-1,8-diamine, 4,7-dioxadecane-1,10-diamine, 4-aminomethyl-1,8-octane diamine and polyoxyalkylene polyamines having two or three amino groups, in particular the products D-230, D-400, D-2000, T-403 and T-5000 from Huntsman that are available under the brand name Jeffamine® as well as similar compounds from BASF or Nitroil as well as mixtures of the polyamines mentioned above. The diamines mentioned above are especially preferred polyamines (PAM).

In addition, to synthesize an aldimine of formula (I), at least one sterically hindered aliphatic aldehyde (ALD) of formula (IV) is used:

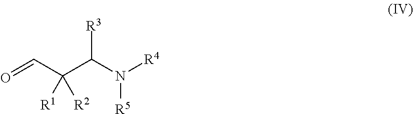

wherein R¹, R², R³, R⁴ and R⁵ have the meanings already given above.

R¹ and R² preferably each stand for a methyl group and R³ preferably stands for a hydrogen atom.

R⁴ and R⁵ preferably, independently of one another, each stand for methyl, ethyl, propyl, isopropyl, butyl, 2-ethylhexyl, cyclohexyl or benzyl or together—including the nitrogen atom—they form a ring, in particular a pyrrolidine, piperidine, morpholine or N-alkylpiperazine ring, where this ring is optionally substituted.

Aldehydes (ALD) of formula (IV) can be obtained in particular as the product of a Mannich reaction or an α-aminoalkylation analogous to the Mannich reaction as is known from the technical literature and which may therefore also be referred to Mannich bases. An aldehyde (Y1) of formula (V), an aldehyde (Y2) of formula (VI) and a secondary aliphatic amine (C) of formula (VII) are reacted here, with elimination of water, to form an aldehyde (ALD)

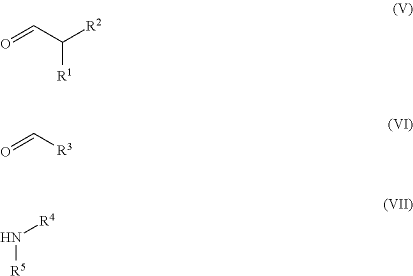

wherein R¹, R², R³, R⁴ and R⁵ have the meanings already given above. This reaction may be performed either with the free reagents, i.e., the aldehyde of formula (V) (Y1), the aldehyde of formula (VI) (Y2) and the amine (C) or the reagents may be used in a partially or completely derivatized form. Thus the aldehyde (Y1) may be used as an enolate, as an enol ether, in particular as a silylenol ether, or as an enamine. The aldehyde (Y2) may be used, for example, in the form of an oligomer—in particular in the case of formaldehyde as 1,3,5-trioxane or as paraformaldehyde—or as a hydrate, hemiacetal, acetal, N,O-acetal, aminal or hemiaminal. Finally, the secondary aliphatic amine (C) may be used in the form of a salt, in particular as an amine hydrochloride or as an amine hydrosulfate or as a silylamine. It is possible to use a portion of the reagents in free form and a portion in derivatized form or to use them only in derivatized forms. When using reagents in derivatized form, the aldehyde (ALD) is also obtained in derivatized form, for example, as a salt under some circumstances. In this case, it may be converted to the free form according to formula (IV) by suitable workup. It may be appropriate to additionally use additives such as Lewis acids or catalysts in such conversion reactions, depending on the conditions.

In addition, the reaction may be carried out as a one-pot reaction, in which all three reagents can react with one another at the same time; or a stepwise procedure may be selected by reacting first two of the reagents with one another and then reacting the resulting intermediate with the third reagent, where the intermediate may or may not be isolated. Such intermediates that are suitable include in particular iminium salts, which are obtained from the reaction of an aldehyde (Y2) in free or derivatized form with a salt of a secondary aliphatic amine (C) and which can be reacted with an aldehyde (Y1) in free or derivatized form to form the corresponding salt of an aldehyde (ALD) of formula (IV). Such a stepwise procedure may be advantageous in permitting milder reaction conditions and thus giving a higher product yield.

In addition, the reaction may take place using solvents, in particular polar solvents such as water or alcohols, or the reaction may be performed without using solvents.

In a preferred specific embodiment, the reaction is carried out as a one-pot reaction with all the reagents in free form and the aldehyde (ALD) is purified by distillation after completing the reaction. It is preferable not to use any organic solvents.

For example, the following aldehydes are suitable as the aldehyde (Y1) of formula (V): isobutyraldehyde, 2-methylbutyraldehyde, 2-ethyl butyraldehyde, 2-methylvaleraldehyde, 2-ethyl caproaldehyde, cyclopentane carboxaldehyde, cyclohexanecarboxaldehyde, 1,2,3,6-tetrahydrobenzaldehyde, 2-methyl-3-phenylpropionaldehyde, 2-phenylpropionaldehyde and diphenylacetaldehyde. Isobutyraldehyde is preferred.

Suitable examples of the aldehyde (Y2) of formula (VI) include the following aldehydes: formaldehyde, acetaldehyde, propionaldehyde, butyraldehyde, isobutyraldehyde, phenylacetaldehyde, benzaldehyde and substituted benzaldehydes as well as glyoxylic acid esters, in particular glyoxylic acid ethyl esters. Formaldehyde is preferred.

Examples of suitable amines (C) of formula (VII) include the following secondary aliphatic amines: dimethylamine, diethylamine, dipropylamine, diisopropylamine, dibutylamine, diisobutylamine, di-sec-butylamine, dihexylamine, di-(2-ethylhexyl)amine, dicyclohexylamine, N-methyl butylamine, N-ethyl butylamine, N-methyl cyclohexylamine, N-ethyl cyclohexylamine, di-2-methoxyethylamine, pyrrolidine, piperidine, N-methyl benzylamine, N-isopropyl benzylamine, N-tert-butyl benzylamine, dibenzylamine, morpholine, 2,6-dimethylmorpholine, bis-(3-dimethylaminoproypl)amine, N-methyl or N-ethyl piperazine.

Preferred examples of the amine (C) include dimethylamine, diethylamine, diisopropylamine, dibutylamine, diisobutylamine, N-methyl cyclohexylamine, N-methyl benzylamine, N-isopropyl benzylamine, N-tert-butyl benzylamine, dibenzylamine, pyrrolidine, piperidine, morpholine, 2,6-dimethyl morpholine, N-methyl- and N-ethyl piperazine.

The aldehyde (ALD) is preferably synthesized by the reaction of isobutyraldehyde as the aldehyde (Y1) of the formula (V), formaldehyde as the aldehyde (Y2) of formula (VI) and one of the amines selected from the group consisting of dimethylamine, diethylamine, diisopropylamine, dibutylamine, diisobutylamine, N-methyl cyclohexylamine, N-methyl benzylamine, N-isopropyl benzylamine, N-tert-butyl benzylamine, dibenzylamine, pyrrolidine, piperidine, morpholine, 2,6-dimethylmorpholine, N-methyl and N-ethyl piperazine as the amine (C) of formula (VII).

Preferred aldehydes (ALD) include 2,2-dimethyl-3-dimethyl aminopropanal, 2,2-dimethyl-3-diethyl aminopropanal, 2,2-dimethyl-3-dibutyl-aminopropanal, 2,2-dimethyl-3-(N-pyrrolidino)propanal, 2,2-dimethyl-3-(N-piperidino)propanal, 2,2-dimethyl-3-(N-morpholino)propanal, 2,2-dimethyl-3-(N-(2,6-dimethyl)-morpholino)propanal, 2,2-dimethyl-3-(N-(4-methylpiperazino))propanal, 2,2-dimethyl-3-(N-(4-ethylpiperazino))propanal, 2,2-dimethyl-3-(N-benzylmethylamino)propanal, 2,2-dimethyl-3-(N-benzylisopropylamino)propanal and 2,2-dimethyl-3-(N-cyclohexylmethylamino)propanal. The preferred aldehydes (ALD) have a comparatively low basicity.

Aldimines of formula (I) can be synthesized directly from polyamines (PAM) having two or more primary amino groups and aldehydes (ALD) of formula (IV), as already described above, by reacting a polyamine (PAM) with an aldehyde (ALD) in a condensation reaction with the removal of water.

The proportion of polyaldimine (PA) is typically between 0.3 and 10% by weight, in particular between 0.5 and 5% by weight, preferably between 1 and 3% by weight, based on the weight of the heat-curing sealing compound composition.

In addition, the polyaldimine (PA) is preferably present in the sealing compound composition in an amount such that the ratio of the number of aldimino groups to the number of isocyanate groups has a value of 0.2 to 0.8, in particular of 0.3 to 0.7.

The heat-curing sealing compound composition described here may contain additional ingredients as needed. In particular these include fillers (F), polyisocyanates (PI), reactive diluents containing epoxy groups (G), and catalysts, stabilizers, in particular heat and/or light stabilizers, thixotropy agents, plasticizers, solvents, blowing agents, dyes and pigments, corrosion preventing agents, surfactants, foam suppressants, adhesion promoters and impact strength modifiers (SM).

The fillers (F) are preferably mica, talc, kaolin, wollastonite, feldspar, syenite, chlorite, bentonite, montmorillonite, calcium carbonate (chalk, precipitated or ground), dolomite, quartz, silicic acids (pyrogenic or precipitated), cristobalites, calcium oxide, aluminum hydroxide, magnesium oxide, ceramic hollow beads, glass hollow beads, organic hollow beads, glass beads, carbon black, graphite, metal powder, ground electrically conductive polymers or colored pigments.

It is especially preferable for the heat-curing sealing compound composition to contain carbon black or other electrically conductive additives, in particular graphite, metal powder or ground electrically conductive polymers as the filler. These lead to a certain conductivity of the sealing compound composition in coating by means of a CDC paint, and this in turn has an advantageous effect on coating results.

Suitable fillers (F) include both the organically coated and the uncoated forms that are available commercially and are known to those skilled in the art.

The total amount of total fillers (F) is preferably 3-50% by weight, especially 5-35% by weight, in particular 5-25% by weight, based on the weight of the total composition.

The polyisocyanates (PI) are oligomers or derivatives of monomeric diisocyanates, in particular HDI, IPDI, TDI and MDI which may act as crosslinking agent and/or as adhesion promoters in the heat-curing sealing compound composition. Suitable polyisocyanates (PI) include, for example, HDI biurets, which are commercially available as Desmodur® N 100 and N 3200 (from Bayer), for example; Tolonate® HDB and HDB-LV (from Rhodia) and Duranate® 24A-100 (from Asahi Kasei); HDI isocyanurates, for example, as Desmodur® N 3300, N 3600 and N 3790 BA (all from Bayer), Tolonate® HDT, HDT-LV and HDT-LV2 (from Rhodia), Duranate® TPA-100 and THA-100 (from Asahi Kasei) and Coronate® HX (from Nippon Polyurethane); HDI uretdiones, for example, as Desmodur® N 3400 (from Bayer); HDI iminooxadiazine diones, for example, as Desmodur® XP 2410 (from Bayer); HDI allophanates, for example, as Desmodur® VP LS 2102 (from Bayer); IPDI isocyanurates, for example, in solution as Desmodur® Z 4470 (from Bayer) or in solid form as Vestanat® T1890/100 (from Evonik); TDI oligomers, for example, as Desmodur® IL (from Bayer); as well as mixed isocyanurates based on TDI/HDI, for example, as Desmodur® HL (from Bayer). In addition, forms of MDI that are liquid at room temperature (so-called “modified MDI”), which are mixtures of MDI with MDI derivatives are also suitable, for example, MDI carbodiimides and/or MDI uretonimines or MDI urethanes, which are known, for example, under brand names such as Desmodur® CD, Desmodur® PF, Desmodur® PC (all from Bayer) and mixtures of MDI and MDI homologs (polymeric MDI or PMDI), that can be obtained under brand names such as Desmodur® VL, Desmodur® VL50, Desmodur® VL R10, Desmodur® VL R20 and Desmodur® VKS 20F (all from Bayer), Isonate® M 309, Voranate® M 229 and Voranate® M 580 (all from Dow) or Lupranat® M 10 R (from BASF).

Forms of MDI that are liquid at room temperature are preferred as the polyisocyanate (PI) as well as the oligomers of HDI, IPDI and TDI, in particular the isocyanurates and the biurets.

The reactive diluents (G) containing epoxy groups include in particular:
glycidyl ethers of monofunctional saturated or unsaturated branched or unbranched cyclic or open-chain C₄ to C₃₀ alcohols, in particular selected from the group consisting of butanol glycidyl ether, hexanol glycidyl ether, 2-ethylhexanol glycidyl ether, allyl glycidyl ether, tetrahydrofurfuryl and furfuryl glycidyl ether, trimethoxysilyl glycidyl ether.
glycidyl ethers of difunctional saturated or unsaturated branched or unbranched cyclic or open-chain C₂ to C₃₀ alcohols, in particular selected from the group consisting of ethylene glycol, butanediol, hexanediol, octanediol glycidyl ether, cyclohexane dimethanol diglycidyl ether and neopentyl glycol diglycidyl ether.
glycidyl ethers of tri- or polyfunctional saturated or unsaturated branched or unbranched cyclic or open-chain alcohols such as epoxidized castor oil, epoxidized trimethylolpropane, epoxidized pentaerythritol or polyglycidyl ethers of aliphatic polyols such as sorbitol, glycerol or trimethylolpropane.
glycidyl ethers of phenol and aniline compounds, in particular selected from the group consisting of phenyl glycidyl ether, cresyl glycidyl ether, p-tert-butylphenylglycidyl ether, nonylphenol glycidyl ether, 3-n-pentadecenyl glycidyl ether (from cashew nut shell oil), N,N-diglycidylaniline and triglycidyl of p-aminophenol.
epoxidized amines such as N,N-diglycidyl cyclohexylamine.
epoxidized mono- or dicarboxylic acids, in particular selected from the group consisting of neodecanoic acid glycidyl ester, methacrylic acid glycidyl ester, benzoic acid glycidyl ester, phthalic acid, tetra- and hexahydrophthalic acid diglycidyl ester and diglycidyl esters of dimeric fatty acids as well as terephthalic acid and trimellitic acid glycidyl ester;
epoxidized di- or trifunctional low- to high-molecular polyether polyols, in particular polyethylene glycol diglycidyl ethers or polypropylene glycol diglycidyl ethers.

Hexane diol diglycidyl ether, cresyl glycidyl ether, p-tert-butylphenyl glycidyl ether, polypropylene glycol diglycidyl ether and polyethylene glycol diglycidyl ether are especially preferred.

The total amount of the reactive diluent (G) containing the epoxy groups is advantageously 0.1-20% by weight, preferably 1-8% by weight, based on the weight of the total composition.

In another especially preferred embodiment, the heat-curing sealing compound composition additionally contains at least one catalyst (KA) which accelerates the hydrolysis of aldimino groups. Such catalysts (KA) include in particular acids, for example, organic carboxylic acids such as benzoic acid, salicylic acid or 2-nitrobenzoic acid, organic carboxylic anhydrides such as phthalic anhydride, hexahydrophthalic anhydride and hexahydromethyl phthalic anhydride, silyl esters of organic carboxylic acids, organic sulfonic acids such as methanesulfonic acid, p-toluenesulfonic acid or 4-dodecylbenzenesulfonic acid, sulfonic acid esters, other organic or inorganic acids or mixtures of the acids and acid esters mentioned above. Salicylic acid or 2-nitrobenzoic acid is most preferably used as the catalyst (KA).

In addition, it is especially advantageous if the heat-curing sealing composition additionally contains at least one catalyst (KN) which accelerates the reaction of the isocyanate groups. Such catalysts (KN) that accelerate the reaction of isocyanate groups include in particular organotin compounds such as dibutyltin diacetate, dibutyltin dilaurate, dibutyltin dichloride, dibutyltin diacetylacetonate and dioctyltin dilaurate, bismuth compounds such as bismuth trioctoate and bismuth tris-neodecanoate and compounds containing tertiary amino groups such as 2,2′-dimorpholinodiethyl ether and 1,4-diazabicyclo[2.2.2]octane.

In addition, it is especially advantageous if the heat-curing sealing compound composition additionally contains at least one rheology modifier (R). Such rheology modifiers (R) include in particular thickeners or thixotropy agents, for example, urea compounds, polyamide waxes, bentonites or pyrogenic silicas.

In addition, it is especially advantageous if the heat-curing sealing compound composition further contains at least one impact strength modifier (SM). In particular, polyurethane polymers that have been reacted with hydroxy functional polyepoxies, in particular those disclosed by formula (II) in US 2009/0288766 A1 or US 2010/0035041 A1, in particular by their formula (I), the entire contents of these patents is included herein by this reference), have proven to be especially suitable impact strength modifiers (SM). In particular the reaction products of the isocyanate group-containing polyurethane polymer (PUP) with the hydroxy functional substances occurring in the epoxy resin (A), these reaction products being formed in the premix already described above, in particular the compound of formula (XII) are also examples of such impact strength modifiers (SM).

The heat-curing sealing compound composition preferably consists essentially, i.e., in particular more than 95% by weight, of:
epoxy resin (A) with an average of more than one epoxy group per molecule;
heat-activatable curing agent or accelerator (B) for epoxy resins;
polyurethane polymer (PUP) containing isocyanate groups;
polyaldimine (PA) of formula (I);
filler (F);
reactive diluent (G) containing epoxy groups;
plasticizer;
catalyst (KA), which accelerates the hydrolysis of aldimino groups;
catalyst (KN), which accelerates the reaction of isocyanate groups;
rheology modifier (R);
impact strength modifier (SM).

It is self-evident that the epoxy resin (A), the heat-activatable curing agent or accelerator (B), the polyurethane polymer (PUP) having isocyanate groups, the polyaldimine (PA), the filler (F), the reactive diluent (G) containing epoxy groups, the catalyst (KA), the catalyst (KN) and the rheology modifier (R) in the present invention are each different substances.

In one embodiment, the composition additionally contains at least one physical or chemical blowing agent, in particular in an amount of 0.1% to 3% by weight, based on the weight of the composition. Preferred blowing agents are chemical blowing agents which release a gas when heated to a temperature of 100 to 200° C. in particular.

These may be exothermic blowing agents such as, for example, azo compounds, hydrazine derivatives, semicarbazide or tetrazoles. Azodicarbonamide and oxy-bis-benzenesulfonyl hydrazide, which release energy in decomposition, are preferred. Also suitable are endothermal blowing agents such as sodium bicarbonate/citric acid mixtures. Such chemical blowing agents are available under the brand name Celogen™ from the company Chemtura, for example. Also suitable are physical blowing agents such as those distributed under the brand name Expancel™ by the company Akzo Nobel.

Especially suitable blowing agents are those that are available under the brand names Expancel™ from the company Akzo Nobel or Celogen™ from the company Chemtura.

The heat-curing sealing compound composition is prepared and stored in the absence of moisture. It is stable in storage, i.e., it can be stored for a period of several months or up to a year or even more in the absence of moisture in a suitable package or configuration, for example, a drum, a bag or a cartridge without any changes in application properties or in its properties after curing of an extent that would be relevant for use thereof. The storage stability is usually determined by measuring the viscosity.

The heat-curing sealing compound composition described in detail above is highly suitable for use as a sealing compound.

The heat-curing sealing compound composition is characterized by extraordinarily good storage stability. This is surprising because two curing agent systems are present in the composition in the form of the heat-activatable curing agent or accelerator (B) for epoxy resins and the polyaldimine (PA) of formula (I) and both of these systems can act on the epoxy groups as well as on the isocyanate groups during storage and can thus trigger premature crosslinking reactions. It is a very tedious process to measure storage stability at room temperature, but experience has shown that accelerated storage at 60° C. is a reliable method for obtaining information about long-term storage stability at room temperature. The change in viscosity of the sealing compound in an aluminum cartridge with an airtight seal after storage for 5 days at 60° C. in a circulating air oven can be used as a measure of long-term storage stability at room temperature. Experience has shown that at most a doubling of viscosity, i.e., an increase of max. 100%, is admissible for reliable use of the composition as a sealing compound. It has been found that the heat-curing sealing compound compositions meet this requirement excellently; changes in viscosity amounting to less than 55% and in some cases even less than 35% can be achieved.

The heat-curing sealing compound compositions are characterized by rapid formation of a skin. They preferably have a skin-forming time of less than 120 minutes, in particular 10 to 100 minutes, especially preferably 20 to 90 minutes.

Within the context of the present invention, the skin-forming time is determined by the method described in detail in the “Examples” section below.

In addition, very few blisters or none at all are formed during the curing of the heat-curing sealing compound compositions. Blisters are usually formed in air curing of polyisocyanates. Blistering is intensified by heat, in particular in temperatures of more than 100° C., which can also lead to foaming. Blistering causes a decline in the mechanical strength values. Furthermore, the visual appearance is severely impaired by blistering or even foaming. Due to the fact that the heat-curing sealing compound compositions form few blisters or none at all during curing, they have excellent mechanical properties and an optimal visual aspect. This is especially important because the CDC paint goes above the surface of the sealing compound and so the sealing compound surface can be seen through the CDC paint and/or the colored paint subsequently placed over it.

Furthermore, the heat-curing sealing compound composition are largely elastic after being cured by heat and may have an extraordinarily good impact strength. This is especially advantageous in the case of seals that are exposed to impacts or movements during use.

This combination of advantageous properties makes it possible for the heat-curing sealing compound compositions to be usable in particular as sealing compounds in autobody work, in particular in the engine space or for doors, trunk lids, tailgates or hoods. In particular they may also be used as the sealing compound in flange fold seals, such as those disclosed in WO 2008/077918 A1.

In another aspect of the present invention, a method for sealing which comprises the following steps, is disclosed:
i) Applying a heat-curing sealing compound composition, such as that described above, to a substrate (S), so that a portion of the surface of the sealing compound composition is in contact with air;
ii) Forming a skin on the surface of the sealing compound composition, which is in contact with the air;
iii) Heating the sealing compound composition to a temperature above 120° C., in particular between 160° C. and 220° C., to form a cured sealing compound composition.

Materials suitable for substrate (S) include in particular metals, in particular those metals which are used in the construction of vehicle bodies of automobiles in particular. These include in particular steels, especially electrolytically galvanized, flame galvanized, oiled steel, Bonazinc-coated steel and subsequently phosphatized steel, or aluminum, in particular in the variants that typically occur in automotive engineering. These include steel plates or aluminum plates in particular.

The application, i.e., the deposition, is preferably performed automatically and in particular in the form of a bead. However, the sealing compound composition may also be sprayed on. Other application methods such as swirl application, flat-stream spraying, mini-flat stream spraying and thin-stream spraying at speeds of >200 mm/s or the like are also conceivable. In addition, a manual application or manual reworking of the applied sealing compound composition by spatula or paintbrush is also possible.

Thus, in another aspect, the present invention also relates to a coated substrate obtained by applying a heat-curing sealing compound composition such as that described in detail above to the surface of a substrate.

In an especially preferred embodiment, the heat-curing sealing compound composition is applied to an oiled steel plate. The advantage of the composition that it adheres well to such a substrate and develops a skin rapidly results in the fact that a heat-curing sealing compound composition can be coated quickly with a paint.

It is thus preferable for a step iia) to be performed between step ii) and step iii):
iia) Applying a paint, in particular a CDC paint, to the sealing compound composition.

Those skilled in the art of automotive engineering are extremely familiar with the concept of a CDC paint, which refers to a paint applied to sheet metal in a CDC bath (CDC=cathodic dip coating).

Step iii) is preferably performed in a CDC oven.

By heating the heat-curing sealing compound composition, further curing takes place, so that the sealing compound composition receives its final strength.

The heat-curing sealing compound composition is suitable for sealing gaps in particular.

It is thus preferable for the heat-curing sealing compound composition to be applied in or to a gap in step i), said gap being bordered by two surfaces of the substrate (S) and a second substrate (S2), the second substrate (S2) being made of the same material as the substrate (S) or a different material.

The heat-curing sealing compound composition is applied in particular in areas where one plate of sheet metal protrudes over a second plate, thus exposing a cut surface and/or a cut edge. The heat-curing sealing compound composition is applied in such a way that this cut edge and cut surface are covered. The sealing compound composition thus not only covers the gap but also covers the cut edge and thereby makes it possible to provide corrosion protection to both.

Thus a sealed article is obtained by the method described above.

### DESCRIPTION OF THE DRAWINGS

The invention is described in greater detail below on the basis of preferred exemplary embodiments with the help of the figures, and it should be pointed out that only the elements essential for a direct understanding of the invention are shown here. The same elements are identified using the same reference numerals in the different figures. In addition, it should be pointed out that the figures shown here are schematic diagrams without any reference to size.

In the drawings:

FIG. 1 shows a schematic cross section through a joining site of two sheet metals;

FIG. 2 shows a schematic cross section through a joining site after treatment with CDC paint without the use of the sealing compound according to the invention;

FIG. 3 shows a schematic cross section through a joining site after application of the sealing compound;

FIG. 4 shows a schematic cross section through a joining site after treatment with CDC paint using the sealing compound according to the invention;

FIG. 5 shows a schematic cross section through a joining site after treatment with CDC paint using the sealing compound according to the invention and with a heat treatment.

FIGS. 1, 3, 4 and 5 also show individual intermediate steps of a method for sealing.

FIG. 1 shows schematically two substrates (S) 2, (S2) 3 which are joined together, for example, by an adhesive or a spot weld. The specific embodiment here shows a joint comprised of two overlapping plates of sheet metal (S) 2, (S2) 3. There is a gap 13 between the plates of sheet metal. The plates are oiled at the surface. The first plate (S) 2 has a cut surface 10. This cut surface no longer has any oil on the sheet metal surface—due to the cutting operation.

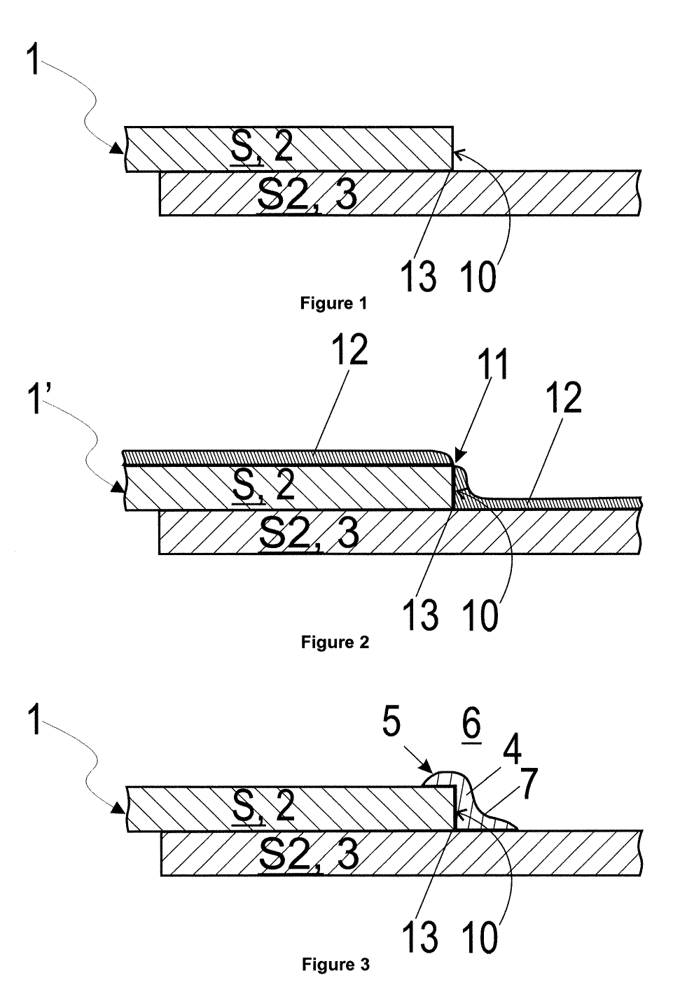

FIG. 2 serves to illustrate one of the main problems with the approach according to the prior art. FIG. 2 shows schematically a joint like that shown in FIG. 1 in which a paint 12, in particular a CDC paint 12, has been applied to the joint 1′ without the use of a sealing compound according to the invention. For the sake of simplicity, the application of paint is shown on only one side of the joint. A location where the paint has not been deposited and the metal has not been covered is formed on the cut edge 11 in particular. This cut edge 11 is part of the cut face 10, which no longer has an oil coating.

FIG. 3 shows schematically a joint 1, such as that shown in FIG. 1, in which a heat-curing sealing compound composition 4 according to the invention has been applied in a first step i) to a substrate (S) 2, i.e., the first sheet metal plate, so that a portion of the surface 5 of the sealing compound composition is in contact with air 6. In addition, the sealing compound has been applied in such a way that it is also applied to the second sheet metal plate. Then in step ii) a skin 7 forms on the surface of the sealing compound composition that is in contact with the air 6.

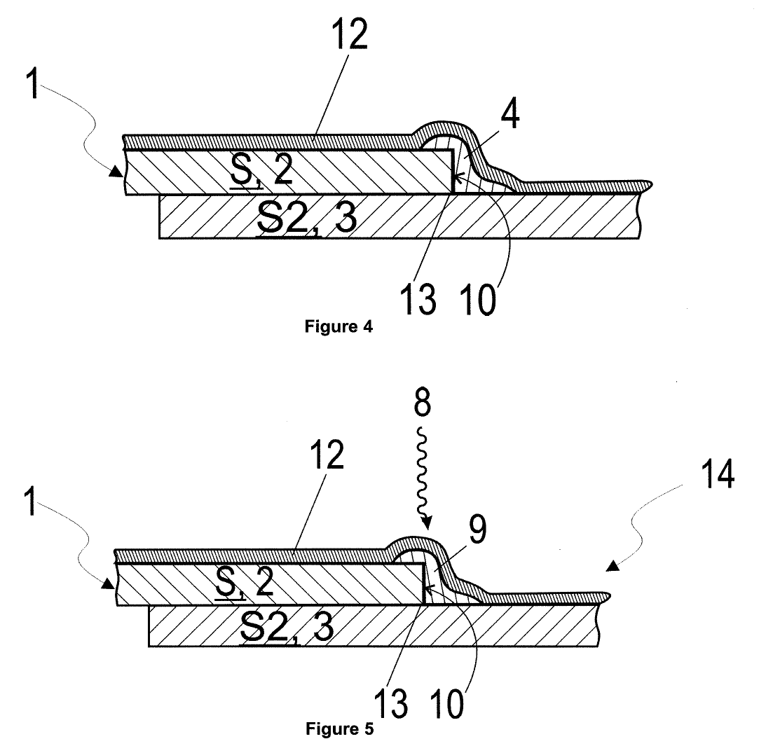

FIG. 4 shows schematically the joint 1 as described above in conjunction with FIG. 3, with which a paint 12, in particular a CDC paint 12, is now applied in a step iia) following step ii). For the sake of simplicity, the application of paint is shown only on one side of the joint here—as is also shown in FIG. 2. The paint 12 covers the surface (outer surface, i.e., exposed to the paint bath) of the joint body completely. In particular it covers the cut edge 11 as well as the cut face 10 completely, so that the two substrates are protected well.

Finally, FIG. 5 shows schematically the joint 1 as described in conjunction with FIG. 4, in which the sealing compound composition is now heated to a temperature of more than 140° C., in particular between 160° C. and 200° C. in a subsequent additional step iii). This heating is performed by a heat source 8 and is represented here schematically by a CDC oven. The sealing compound composition 4 is cured as a result of the heating, forming a fully cured sealing compound composition 9. A sealed article 14 is thus formed. The cut edges 11 and cut faces 10 of the sheet metal are protected well and reliably from the effects of corrosive media in this sealed article.

### EXAMPLES

The examples presented below serve only to illustrate the present invention.

Table 1 lists the raw materials that were used.

TABLE 1
Raw materials used.

| | |
|---|---|
| D.E.R. 330 (bisphenol A diglycidyl ether = “DGEBA”) | Dow |
| Poly bd ® R-45HTLO (hydroxyl-terminated polybutadiene) | Arkema |
| (OH equivalent weight = approx. 1200 g/Eq) | |
| Isophorone diisocyanate (= “IPDI”) | Evonik |
| 1-Amino-3-aminomethyl-3,5,5-trimethyl cyclohexane | Evonik |
| (isophorone diamine = “IPDA”) | |
| Dicyanodiamide (= “Dicy”) | Evonik |
| (micronized: grain size: 98% < 6 μm) | |

### Preparing a Premix Containing Epoxy Resin and Polyurethane Polymer Having Isocyanate Groups: VM1

417.5 g of Poly BD® R-45HTLO and 154.2 g of DGEBA were stirred together with 328.6 g of diisodecyl phthalate (DIDP) in vacuo at 80° C. A 0.8 g of catalyst solution (10% by weight dibutyltin dilaurate (DBTDL) in diisononyl phthalate) was added. Next, 98.9 g of IPDI was added while stirring and the mixture was stirred for 2 hours at 80° C. The premix of polyurethane polymer and epoxy resin thus formed had an NCO content of 1.6% by weight and an epoxy content of 0.82 mol Eq/kg. The premix identified as VM1 was used as is.

### Preparing a Polyaldimine PA-1

A round-bottom flask was charged with 14.55 g of IPDA under a nitrogen atmosphere. While stirring vigorously, 30.00 g of 2,2-dimethyl-3-(N-morpholino) propanal was added from a dropping funnel. Next, the volatile ingredients were removed in vacuo (10 mbar, 80° C.). Yield: 40.9 g of a clear, colorless oil having an amine content of 8.29 mmol N/g.

### Preparing a Polyaldimine PA-Ref

A round-bottom flask was charged with 20.00 g of IPDA under a nitrogen atmosphere. While stirring vigorously and cooling with ice, 18.63 g of isobutyraldehyde was added from a dropping funnel, and the mixture was then stirred for 30 minutes at room temperature. Next, the volatile ingredients were removed in vacuo (10 mbar, 80° C.). Yield: 32.6 g of a clear, colorless oil with an amine content of 7.17 mmol N/g.

### Preparing Heat-Curing Sealing Compound Compositions

Using the ingredients indicated in parts by weight in Table 2, various heat-curing sealing compound compositions were prepared in the absence of moisture. After their preparation, the compositions were packaged in moisture-proof aluminum cartridges and were used directly for testing.

### Measurement Methods

The following properties of the compositions were measured:

Storage Stability

To determine the storage stability, the viscosity (η₀) at 20° C. was measured directly using a plate-plate viscometer (Anton Paar Physica MCR 101, gap 200 μm, shear rate: linear rise 0.1-10 s⁻¹, duration 2 minutes, the last point being taken as the viscosity value) of the composition. Next, the sealed aluminum cartridge was stored for 5 days at 60° C. in a circulating air oven, and after cooling to room temperature, the viscosity was measured again (n_{5d, 60° C.}). The change in viscosity is determined according to the following equation and is given in percent in Table 2 as a measure of the storage stability:

Δ_{visc, 5d, 60° C.}=(η_{5d, 60° C.}/η₀)−1

A large change in viscosity is a sign of inadequate storage stability. A change in viscosity of more than 100% is inadequate.

Formation of a Skin

To determine the skin formation time (“SFT”), the sealing compound at room temperature was applied to cardboard in a layer thickness of approx. 3 mm and the time until no residues of sealing compound remained on the pipette for the first time when tipping lightly on the surface of the sealing compound by means of a pipette made of LDPE, was determined in a standard atmosphere (STP; 23±1° C., 50±5% relative humidity).

Blistering

The sealing compound was applied to a PTFE sheet and then pressed using a second PTFE sheet to a layer thickness of 2 mm. Next the second PTFE sheet was removed and the sealing compound was cured for 120 minutes at 23° C. and 50% relative humidity and then heated for 20 minutes at 180° C. in a circulating air oven. Next, the cured film was evaluated for blistering. If no blistering could be detected, the evaluation was “none”; if isolated blisters were discovered, the evaluation was “a few” and if many blisters were found, i.e., it was a foamy structure, the evaluation was “many.”

TABLE 2
Compositions and properties.

| | 1 | 2 | 3 | Ref. 1 | Ref. 2 | Ref. 3 | Ref. 4 | Ref. 5 | Ref. 6 |
|---|---|---|---|---|---|---|---|---|---|
| VM1 | 47.7 | 47.7 | 47.7 | 47.7 | 47.7 | 47.7 | 47.7 | 47.7 | 47.7 |
| PA-1 | 1.8 | 1.8 | 1.8 | | | | | | 1.8 |
| PA-Ref | | | | 1.2 | 1.2 | 1.2 | 1.2 | 1.2 | |
| Dicy | 1.0 | | | | 1.0 | | 1.0 | | |
| DMA¹ | | 1.0 | | | | 1.0 | | 1.0 | |
| Amidoamine² | | 2.0 | 2.0 | 2.0 | | | 2.0 | 2.0 | |
| Catalysat³ | 1.2 | 1.2 | 1.2 | 1.2 | 1.2 | 1.2 | 1.2 | 1.2 | 1.2 |
| Chalk | 34.6 | 32.6 | 33.6 | 34.2 | 35.2 | 35.2 | 33.2 | 33.2 | 35.6 |
| Calcium | 3.7 | 3.7 | 3.7 | 3.7 | 3.7 | 3.7 | 3.7 | 3.7 | 3.7 |
| oxide | | | | | | | | | |
| SiO₂⁴ | 10.0 | 10.0 | 10.0 | 10.0 | 10.0 | 10.0 | 10.0 | 10.0 | 10.0 |
| Δ_{visc,5d 60°C.} | 52 | 81 | 30 | 150 | x⁶ | x⁶ | x⁶ | 414 | 17 |
| [%] | | | | | | | | | |
| SFT⁷ [min] | 30 | 90 | 90 | 120 | 10 | 30 | 30 | 150 | 180 |
| Blistering | a | a | none | none | many | many | none | many | n.c.⁸ |
| | few | few | | | | | | | |

¹DMA = N,N-dimethyl urea
²Amidoamine = 1:1 adduct of phthalic anhydride and diethylene triamine
³Catalyst = 1% by weight benzoic acid in diisononyl phthalate
⁴SiO₂ = pyrogenic silica
⁶x = cartridge cured after storage in heat
⁷SFT = skin forming time
⁸n.c. = not cured

Table 2 shows that the Examples 1, 2 and 3 according to the invention, which contain epoxy resin, a polyurethane polymer, which has isocyanate groups, a heat-activatable curing agent or accelerator as well as a polyaldimine of formula (I) have a combination of good storage stability, rapid formation of a skin and minimal bubbling. The comparative examples Ref. 1, Ref. 2, Ref. 3, Ref. 4 and Ref. 5 all contain a polyaldimine (PA-Ref), which does not conform to formula (I). Accordingly, they have a poor, i.e., inadequate storage stability. The comparison of comparative example Ref. 6 with Example/shows that in the absence of the heat-activatable curing agent or accelerator, the composition does not cure in the heat and consequently cannot be used as a sealing compound.

The comparison of Examples 1 and 2 and 3 shows that the use of dicyanodiamide as a heat-activatable curing agent or accelerator has advantageous effects on the rapid development of a skin. This is very surprising because it would have to be assumed that a heat-activatable curing agent or accelerator for epoxies would primarily affect the heat curing and not the formation of a skin at room temperature.

### LIST OF REFERENCE NUMERALS

1,1′ Joint
2, S First substrate
3, S2 Second substrate
4 Heat-curing sealing compound composition
5 Surface of the sealing compound composition
6 Air
7 Skin
8 Heat source
9 Cured sealing compound composition
10 Cut face
11 Cut edge
12 Paint, CDC paint
13 Gap
14 Sealed article

1. A heat-curing sealing compound composition, comprising:
at least one epoxy resin (A) with an average of more than one epoxy group per molecule;
at least one heat-activatable curing agent or accelerator (B) for epoxy resins;
at least one polyurethane polymer (PUP) having isocyanate groups and
at least one polyaldimine (PA) of formula (I) 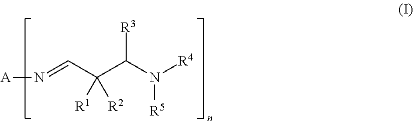
wherein
A stands for the radical of an amine after removal of n-primary aliphatic amino groups and does not contain any active hydrogen atoms, n stands for 2-5, and
R¹ and R² either,
independently of one another, stand for a monovalent hydrocarbon radical each with 1 to 12 carbon atoms,
or
together stand for a divalent hydrocarbon radical with 4 to 12 carbon atoms, which is part of an optionally substituted carbocyclic ring having 5 to 8 carbon atoms;
R³ stands for a hydrogen atom or an alkyl group or an aralkyl group or an alkoxycarbonyl group in particular having 1 to 12 carbon atoms;
R⁴ and R⁵ either
independently of one another, each stands for a monovalent aliphatic, cycloaliphatic or araliphatic radical having 1 to 20 carbon atoms, optionally containing heteroatoms in the form of an ether oxygen or a tertiary amine nitrogen,
or
together they stand for a divalent aliphatic radical having 3 to 20 carbon atoms, which is part of an optionally substituted heterocyclic ring having 5 to 8 ring atoms, preferably 6 ring atoms, wherein this ring optionally contains, in addition to the nitrogen atom, further heteroatoms in the form of ether oxygen or tertiary amine nitrogen.

2. The heat-curing sealing compound composition according to claim 1, wherein R⁴ and R⁵
either
each, independently of one another, stands for methyl, ethyl, propyl, isopropyl, butyl, 2-ethylhexyl, cyclohexyl or benzyl,
or
together—including the nitrogen atom—they form a ring, in particular a pyrrolidine, piperidine, morpholine or N-alkyl piperazine ring, wherein this ring is optionally substituted.

3. The heat-curing sealing compound composition according to claim 1, wherein the weight ratio of epoxy resin (A) to polyurethane polymer (PUP) containing isocyanate groups is between 0.1 and 0.5.

4. The heat-curing sealing compound composition according to claim 1, Wherein the polyaldimine (PA) is present in an amount in the sealing compound composition, such that the ratio of the number of aldimino groups to the number of isocyanate groups has a value of 0.2 to 0.8.

5. The heat-curing sealing compound composition according to claim 1, wherein the heat-activatable curing agent or accelerator (B) for epoxy resins is solid at room temperature and has a melting point of more than 80° C.

6. The heat-curing sealing compound composition according to claim 1, wherein the heat-activatable curing agent or accelerator (B) for epoxy resins is selected from the group consisting of dicyanodiamide, guanamines, guanidines, aminoguanidines and their derivatives; substituted ureas, imidazoles and imidazole salts, imidazolines, amidoamines, iminoamines as well as amine complexes of a Lewis acid.

7. The heat-curing sealing compound composition according to claim 1, wherein the heat-activatable curing agent or accelerator (B) for epoxy resins is a nonaromatic urea.

8. The heat-curing sealing compound composition according to claim 6, wherein the heat-activatable curing agent or accelerator (B) is an amidoamine with a primary amino group, which can be obtained from the reaction of phthalic anhydride and a polyamine with primary amino groups, in particular diethylene triamine (DETA) or triethylene tetramine (TETA).

9. The heat-curing sealing compound composition according to claim 1, wherein the sealing compound composition additionally contains carbon black or other electrically conductive additives, in particular graphite, metal powder or ground electrically conductive polymers as fillers.

10. A coated substrate obtained by applying a heat-curing sealing compound composition according to claim 1 to the surface of a substrate.

11. A method for sealing, comprising the steps of
i) Applying a heat-curing sealing compound composition according to claim 1 to a substrate (S), so that a portion of the surface of the sealing compound composition is in contact with air;
ii) Forming a skin on the surface of the sealing compound composition which is in contact with the air;
iii) Heating the sealing compound composition to a temperature between 160 and 220° C., forming a fully cured sealing compound composition.

12. The method for sealing according to claim 11, wherein a step iia) is performed between steps ii) and iii):
iia) Applying a paint, in particular a CDC paint to the sealing compound composition.

13. The method according to claim 11, wherein step iii) is performed in a CDC oven.

14. The method according to claim 11, wherein the heat-curing sealing compound composition (1) in step i) is applied to or into a gap, which is bordered by two surfaces of the substrate (S) and the second substrate (S2), the second substrate (S2) being made of the same material as the substrate (S) or a different material.

15. A sealed article obtained by a method according to claim 11.
